(19) United States
(12) Patent Application Publication
(10) Pub. No.: US 2017/0352285 A1
(43) Pub. Date: Dec. 7, 2017

(54) SYSTEM AND METHOD OF MONITORING BEHAVIOR AND ENGAGEMENT USING A MOBILE DEVICE

(71) Applicants: Mats A. Selen, Tuscola, IL (US); Timothy J. Stelzer, Urbana, IL (US); Michel G. Herquet, Emines (BE)

(72) Inventors: Mats A. Selen, Tuscola, IL (US); Timothy J. Stelzer, Urbana, IL (US); Michel G. Herquet, Emines (BE)

(21) Appl. No.: 15/611,407

(22) Filed: Jun. 1, 2017

Related U.S. Application Data
(60) Provisional application No. 62/392,489, filed on Jun. 3, 2016.

(51) Int. Cl. G09B 5/14; G09B 7/07; G09B 7/06

(52) U.S. Cl. CPC G09B 5/14; G09B 7/06; G09B 7/07

(57) ABSTRACT

The system set forth herein relates to a network formed between an instructor device and one or more student devices where the system monitors sensors in the student devices to determine whether the student is distracted. The instructor is able to identify operating parameters for the system in the form of rules. The student devices must follow the rules, and where the system detects a rule violation, a warning may be issued to the instructor, student, or both. This allows students to have their mobile devices (such as cell phones or tablets) in class, and even use the mobile devices to participate in class, but also allows the instructor to remotely control and monitor how those student devices are being used.

### CROSS-REFERENCE TO RELATED APPLICATIONS

This application claims priority to U.S. Provisional Application Ser. No. 62/392,489 filed Jun. 3, 2016, the entirety of which is incorporated herein by this reference for all purposes.

### BACKGROUND

Classroom response systems provide a pedagogically valuable teaching tool. Polling students during lecture can provide both the instructor and the students with valuable formative feedback about the level of content knowledge of the class as a whole, as well as the performance of individual students. Classroom response systems are currently used by millions of students in tens of thousands of classrooms across North America. While the “classroom” is a prototypical environment in which such response systems are often used, classroom response systems may, and often are, used in a wide variety of comparable applications where feedback from a group is required, including, for example, business meetings and live voting events.

Classroom response systems can be broadly classified into two categories: Those using dedicated proprietary hardware and those using common mobile devices. Such common mobile devices are not dedicated to a singular task, like voting, and include cell phones, smart phones, personal digital assistants, tablets, laptops, and other electronic devices designed principally to be portable and operable by individuals in multiple locations throughout the day.

In systems that use dedicated proprietary hardware to implement wireless communication between the students and the instructor, each student owns a dedicated “clicker” which they use to participate in class. Examples of such devices are disclosed in U.S. Pat. No. 7,330,716 issued to Adkins, U.S. Pat. No. 7,715,780 issued to Beamish et al, and U.S. Patent Application Publication No. 2003/0236891 filed on behalf of Glass, et al.

In systems using mobile devices, a wireless local area network or a cellular data network is used to implement wireless communication between the students and the instructor. The mobile devices are not dedicated to the transmission and receipt of classroom participation information. Instead, the mobile devices exhibit functionality independent from classroom polling. Such functionality may include internet browsing capability, text messaging, calculator functions, note taking and retrieval programs, imaging capabilities, audio recording and play back, and the capacity to run “apps.”

In a typical implementation of the mobile device classroom response system, a student runs a dedicated application on their mobile device. This application can receive questions and commands from an application being run by the class instructor on a different device, and allows students to interact with the instructor in a pedagogically meaningful way. Since many students already own mobile devices, the typical implementation of the mobile device classroom response system has the potential to increase convenience and lower the cost of participating in a class. This leads to an increase in use of mobile devices in classroom response systems.

A key pedagogical aspect of any classroom response system is that the system itself does not distract students from the lesson being presented by the instructor. Classroom response systems that use proprietary hardware minimize distraction by designing the devices used by students to be simple to operate and unable to perform other functions. Distraction can be much more of a problem when students use mobile devices to participate in class since the mobile devices have the ability for non-classroom related activities such as entertainment, using apps, accessing information on the internet, and communicating with others using various forms of social media. It is also difficult for an instructor to determine whether a student is using the mobile device at all, is using the mobile device for classroom activity, or using it for non-classroom related activities. Thus, the use of mobile devices can be a source of distraction for students and also present a severe security problem in cases where an instructor wants to use the classroom response system for testing.

Mobile devices contain sensors that allow an application running on the device to monitor the orientation and motion of the mobile device. They also contain sensors that allow an application running on the device to monitor the conditions surrounding the device, such as light intensity, sound intensity, temperature, and atmospheric pressure. Mobile devices can also monitor programs running on the mobile device, for example to determine whether the program alters the operation of the sensors of the mobile device, such as by shutting down the operation of the sensor.

The nature of a student's engagement and behavior in class, as well as the nature of the student's surroundings, is correlated with the quality of the student's learning. It is important that students engage with their instructor and with classroom material in a focused way. This engagement level can change from moment to moment and depends on factors such as a student's level of distraction, and a student's surroundings in the classroom. It is of pedagogical benefit for an instructor to be able to monitor and assess the level and quality of engagement of each student in their classroom as well as to maintain a historical record of that engagement on a student-by-student basis.

The nature of a student's engagement and behavior in class can be monitored and assessed by using information gathered from sensors in the student's mobile device. The present system enables instructors to monitor the engagement and behavior of students in class through feedback from the student's mobile device, and to provide ways of discouraging behavior that inhibits learning.

SUMMARY

In general, the present system provides for communication between an instructor device, which may be a mobile device, dedicated hardware device, or personal computer, and at least one student device which is a mobile device. In most instances, the classroom will comprise more than a single student and single instructor, and in such situations it should be understood that the description provided herein with respect to the operation of the system as between the one instructor (with one instructor device) and one student (with one mobile device) can be applied in the same manner to a classroom with one instructor (with one instructor device) and multiple students (with multiple mobile devices).

The instructor device includes a software application for classroom participation. The student device includes a corresponding classroom participation application. Both the instructor device and student device run their respective software application during a class time.

Running the classroom participation applications simultaneously allows the devices to communicate with each other. The instructor device is able to transmit data to the student device, and the student device can wirelessly transmit data to the instructor device. Each can receive the data transmitted by the other and process that data. Thus, the instructor device can transmit question data, which may include instructions to the student device to display, for example, a question in text or pictorial form and also display, for example, a set of multiple choice answers. The student device can receive the question data, process it, and display the appropriate material in accordance with the question data received. The student may then provide an answer and the student device will transmit the answer data to the instructor device. The instructor device may then process the student answer data, which may include an indication of the student's identity and the student's answer, and then store that information, display the information, store or display some related information (such as a bar graph that totals all of the students' answers), or some combination thereof.

The instructor device can also send instructional data to the student device providing an instruction to the student device to enter Distraction Monitoring mode. The student device receives the instructional data and process it. The student software application then controls the student device in accordance with the instruction. In some embodiments, the instructional data may be included in, or sent at the same time as question data. The instructional data and question data may also be transmitted separately and at different times. The instructor device can also send instructional data to the student device providing an instruction to the student device to suspend or stop Distraction Monitoring mode.

In Distraction Monitoring mode the student software application will use at least one of the sensors of the student device to monitor the operation of the student device. For example, the software application can monitor how the device moves to determine whether the student has picked the student device up or turned it over to provide access to the display of the student device. It can monitor the photo sensors of the device to determine if the student is recording information or determine whether the orientation of the student device has moved such that the amount of light sensed by the photo sensor has changed. It can monitor the orientation of the phone through absolute positioning data gathered, for example, by the accelerometer. It can monitor the microphone of the student device to determine if students are talking. It can monitor the applications running on the student device, for example to determine whether an application is affecting the operation of a sensor of the student device.

Thus, using the student's mobile device as a proxy for the student's attention, the system can generalize whether a student is distracted. For example, if the instructor is providing a lecture that requires listening but no response by the student, but the student device senses an acceleration indicating that the mobile device is being turned, that indicates that the student's attention has shifted from listening to the lecture to moving the mobile device and thus the student is distracted. The present system uses the information gathered from the sensors to determine if the student device is outside of acceptable operating parameters and alert the student, instructor, or both of the distracted behavior and thereby discourages or prevents the distracted behavior which in turn promotes learning by the student.

### BRIEF DESCRIPTION OF THE DRAWINGS

FIG. 1 is a depiction of the general structure communication and operation between an instructor device and a plurality of student devices.

FIG. 2 is a depiction of an embodiment showing the structure, communication, and operation between an instructor device and one student device as exemplary of structure, communication, and operation between the instructor device and one or more student devices.

FIG. 3 is a flowchart describing the operation of one embodiment of the system.

### DETAILED DESCRIPTION OF EMBODIMENTS

Embodiments of the present system are described herein for explanatory purposes. It should be appreciated that each of the embodiments described herein may include more or less functionality than what is described with reference to one of the embodiments. Features described with respect to one embodiment may be included or omitted from other embodiments. Although the present system has been described in terms of one embodiment, it is to be understood that such disclosure is not intended to be limiting. Various alterations and modifications will be readily apparent to those of skill in the art. Accordingly, it is intended that the appended claims be interpreted as covering all alterations and modifications as fall within the spirit and scope of the invention.

Generally, the present system is designed for use in classroom learning environments. However, it may also be utilized in any environment in which it is desirable to encourage the attention of individuals while still allowing the individuals periodic or continual access to mobile devices. Such environments include business meetings, lectures, social gatherings, and more. Regardless of the environment, the individual leading the group may be considered an “instructor,” and the remainder of the individuals may be considered “students.” These terms are used for explanatory purposes to easily differentiate between individuals and should not be interpreted as requiring that the either the instructor or student exhibit any particular personal qualities.

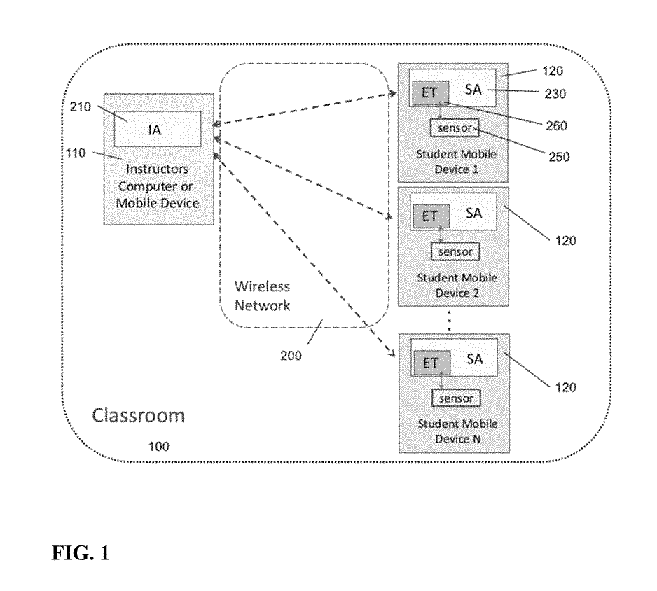

For explanatory purposes and with reference to FIG. 1, the system described here may be used in a classroom 100. A classroom 100 can be either a traditional physical space in which an instructor interacts with a group of students in person, or a virtual space in which an instructor interacts with a group of students remotely.

In one embodiment, the system utilizes an instructor device 110. The instructor device is preferably a mobile device or desktop computer, though it may also be a plug-in, or add-on device that interfaces with a mobile device or desktop computer to collectively operate as the instructor device. The instructor device includes an Instructor Application (IA) 210. The Instructor Application is a software application that may be used by the instructor to perform the various functions of the system. The Instructor Application runs on the instructor device 110. The system further includes a Student Application (SA) 230. The Student Application is a software program that runs on a student device 120. As used herein, a “student device” is a mobile device and a mobile device is a device that is not dedicated to a singular task, like voting, rather such a mobile device includes cell phones, smart phones, personal digital assistants, tablets, laptops, and other electronic devices designed principally to be portable and operable by individuals in multiple locations throughout the day and useful to the student independent of classroom activity. Specific examples of mobile devices that are suitable for use as a student device 120 are the Apple iPhone®, Samsung Galaxy® phones, and Apple iPad®. In one embodiment, each student device includes a copy of the Student Application. For ease of reference, the description of the system provided herein generally refers to the operation of a single student device, though it should be understood that this description is equally applicable to multiple student devices operating independently from one another and operating at the same or at different times.

The operation of the system begins with the instructor enabling the Instructor Application 210 on the instructor device 110 to allow the Instructor Application to run and the student enabling the Student Application 230 on the student device 120 to allow the Student Application to run. Either application may be enabled first, though, for the system to operate properly, both must eventually be enabled so that both are running simultaneously. In one embodiment, the student's enabling the Student Application to run also includes the student agreeing to, for example, allowing certain functions and operations to occur, such as providing the Student Application access to sensor data, permitting the Student Application to send and receive data, other permissions, or some combination thereof. In some embodiments these permission may be required or granted every time the Student Application is enabled. In other embodiments the permissions may be granted only once or at some random or periodic interval.

Those skilled in the art will appreciate that the Instructor Application 210 can be part of a larger application, such as an application used to conduct polling in the classroom, or a program that may perform other functions in context of classroom activities. Similarly, the Student Application 230 may be part of a larger application, such as an attendance application or assignment calendar application, and it may perform other functions apart from those involved in the present system.

In one embodiment, the student device 120 and the instructor device 110 are equipped to communicate wirelessly over a wireless network 200. Such wireless communication is well known in the art and the particular method of wireless communication is immaterial. However, an example of standard wireless protocols that the devices could use is IEEE 802.11. Using the wireless networks, the instructor device is capable of transmitting and receiving data, including transmitting and receiving various instructions and notifications. Similarly, using the wireless networks, student devices are capable of transmitting and receiving data, including transmitting and receiving various instructions and notifications. The Instructor Application 210 may work in connection with the instructor device 110 to transmit and receive data and the Student Application 230 may work in connection with the student device 120 to transmit and receive data. The Instructor Application 210 may send and receive data to and from the Student Application 230 and the Student Application 230 may send and receive data to and from the Instructor Application over wireless network 200. It should be understood that the instructor device need not transmit and receive wireless data directly. For example, the instructor device may be a personal computer with no wireless transmitter or receiver, but it may be connected to an auxiliary device, or connected to a network, that is capable of transmitting and receiving wireless signals. Thus, in such a configuration, the instructor device still transmits and receives wireless signals and communicates with student devices wirelessly, albeit indirectly.

In one embodiment Student Application 230 has access to or receives information from sensors 250 integrated, attached, or programmed into the student device 120. Typical examples of such sensors measure acceleration, orientation, rotation, magnetic field, sound intensity, light intensity, and atmospheric pressure. For example, sensors may include the on/off button, volume button, Bluetooth connection, touch screen, keyboard buttons, software application that monitor which programs are running, and other sensors. The Student Application also has access to data pertaining to the operation of programs or apps (both of which are considered “programs”) on the student device. It should be understood that monitoring sensors based in hardware, such as an accelerometer, or monitoring program operation based in software may all be considered to constitute monitoring sensors of the student device. In some embodiments only the operation of hardware sensors may be “sensed” and monitored by the Student Application 230. In some embodiments only the operation of software may be “sensed” and monitored by the Student Application 230. In some embodiments the operation of both may be “sensed” and monitored by the Student Application 230. Those skilled in the art will appreciate that sensors in current and future mobile devices will measure quantities in addition to those listed above

Information from these sensors can be used as a proxy for student engagement and behavior. When, for example, changes to a student device are sensed by the sensors and identified by the Student Application, the changes serve as an indicator that the student corresponding to the student device is no longer devoting full attention to the instructor. The Student Application may monitor the change sensed and assess whether the change is significant enough to constitute a determination that the student is distracted. It should be understood that the assessment that the student is distracted is independent of whether the student is, in fact, distracted, and the actual mental state of the student is immaterial to operation of the present system. In some embodiments, any change significant enough to register on the sensors of the mobile device may be considered by the Student Application to constitute a determination that the student is distracted. In some embodiments, threshold values for changes sensed by sensors may be stored and accessible to the Student Application, Instructor Application, or both. The Student Application may monitor the sensors and compare data about the change sensed to the threshold value. When the change sensed meets or exceeds the threshold value, the Student Application may determine that the student is distracted. It should be understood that changes sensed by the sensors may correspond to one or more rules defining the acceptable operation parameters for the student device, and that when the system identifies the change (or other sensor data), it may compare the data to the rule(s) to determine if a violation of any rule(s) has occurred.

In what follows, information that can be used to monitor student engagement and will be referred to as Engagement Telemetry (ET) 260. Those skilled in the art will appreciate that Engagement Telemetry 260 is data and it may comprise raw data from the sensors in the student device 120, analyzed data from the sensors in the student device 120, or a combination or raw and analyzed data from the sensors in the student device 120 as well as other information about student device and the nature of any change sensed (for example, the name of the student owning the device and the time the change was sensed).

The Engagement Telemetry 260 may be read or acquired by the Student Application 230 and may be stored locally in the student device 120. The Engagement Telemetry 260 from student device 120 contains data that can be used to assess the student's engagement and behavior in class. An analysis of Engagement Telemetry 260 can be done by the Student Application 230, by the Instructor Application 210, or by a combination of both the Student Application 230 and the Instructor Application 110.

In one embodiment the Engagement Telemetry 260 data is transferred from the Student Application 230 to the Instructor Application 210 after the Student Application 230 determines that the data should be sent. In one embodiment the Engagement Telemetry 260 is transferred from the Student Application 230 to the Instructor Application 210 after the Instructor Application 210 determines that the data should be sent. It should be appreciated that the actual Engagement Telemetry data need not be sent, but instead a result of an analysis of the Engagement Telemetry data may be sent in either case.

When the analysis of Engagement Telemetry 260 indicates that the engagement or behavior of a student is not pedagogically productive, such as an indication that the student is distracted, the student device can provide feedback to the student to improve the student's engagement or behavior. In one embodiment, the analysis of the data includes comparing data relating to the sensors to preset rules. The instructor can input certain rules into the Instructor Application that, if violated, constituted distracted behavior. These rules may be accessible to the Student Application such as through remote access to the Instructor Application or by download. The rules may be included in the Student Application by default. The Student Application identifies data relating to one or more sensors, compares the data (or an analysis of the data) to the rules and determines if any rule is violated.

For example, one rule may be that the student is not permitted to have their device oriented face-up. Where the device starts face-down changes in the sensors are used to determine a rule violation. For example, when the sensors, such as camera photo sensor on the back of the device senses a decrease in light, that is interpreted as the device turning over as the photo sensor is changing from receiving full overhead light of the classroom to facing the desk where there is less light reflecting from the surface of the desk. In addition, or alternatively, the accelerometer sensor may sense the movement of the device as it is being picked up or rotated and interpret that movement as the device turning over in violation of the rule. In another scenario, when the device starts face-up, data from the sensors can be used to identify that face-up orientation and signal that it violates the rule, even though no change occurred. For example, the student device's accelerometer may continuously (or near continuously) determine absolute measurements used to determine acceleration in the x, y, and z, directions, and the system may monitor those measurement values. When the student device is in the face-up position, the z component of the device will be different than the z component of the device when the device is in the face-down position. For example, when the device is face-down, the z component value may be negative, whereas when the device is face-up, the z component value may be positive, thus indicating the devices orientation. The system may compare the measurement values with the rules to determine that the student device is in violation of the rule prohibiting face-up orientation.

When a rule is violated the Student Application may issue a warning to the student through feedback on the student device, send a notification to the Instructor Application, or both. The notice to the Instructor Application may include an identification of the student device, an identification of the type of distracted behavior sent, an identification of the rule violated, the time of the distracted behavior, other data, or a combination thereof. Examples of rules include an identification of whether a change sensed by a particular sensor should be considered distracted behavior, preset threshold values corresponding to one or more of the sensors, a list of acceptable programs that are or are not permitted, Boolean rules that consider the operation of multiple sensors operating simultaneously, or combinations thereof.

In one embodiment, data relating to the Engagement Telemetry is stored, at least temporarily on the student device. For example, the student may begin to move the student device, the sensors sense the movement and generate data that is then used to determine that a violation of the rule against moving the student device has occurred. That data is stored on the student device and the student device issues a warning. The student device may also transmit the Telemetry Data to the instructor. However, it is possible that the student may terminate the Distraction Monitoring mode before the student device has fully transmitted the Telemetry Data, either by exiting the program, shutting down the student device, or removing the student device battery in an attempt to prevent the student device from transmitting the Telemetry Data. The student device may store the Telemetry data and wait until the student device is connected to the system again, at which time it may transmit the Telemetry Data. The Instructor device may also transmit and acknowledgement of the receipt to of the Telemetry Data which may serve as an indicator to the student device that it may delete the temporarily stored Telemetry Data.

Analysis of the Engagement Telemetry can be used to provide immediate feedback to the student, instructor, or both. Analysis of the Engagement Telemetry can also happen after class. The analysis, its results, or both, may be stored by either or both of the Student Device and Instructor Device. In either case, the analysis of the Engagement Telemetry may provide either or both of a formative and summative assessment. In one embodiment, the Instructor Application can generate reports of the Engagement Telemetry data. For example, the Instructor Application may gather Engagement Telemetry data and populate a bar graph of instances of distracted behavior experienced by individual students during the class. As another example, the Instructor Application could populate a curve of total instances of distracted behavior over time regardless of the student. These reports could be generated in real time or after class. The data could also be analyzed from class to class, for example to provide the instructor with historical information about student's behavior over a semester. Such information may also be useful to the professor to help assess whether particular lectures tend to be more or less engaging irrespective of student, or whether certain times of the day tend to give rise to more distracted behavior. It should be appreciated that other individual reports or combinations of reports could also be generated based on the Engagement Telemetry data.

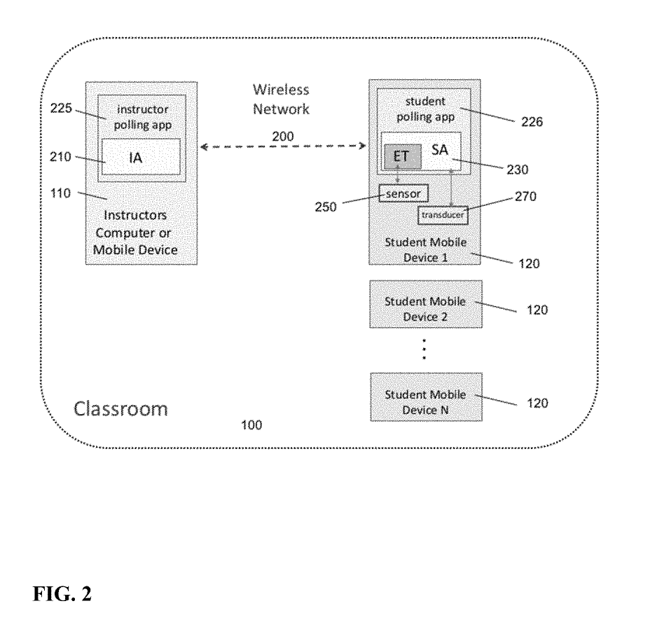

The operation of embodiments of the present system during a typical classroom session may be further understood with reference to FIG. 2. FIG. 2 depicts an embodiment where the Instructor Application 210 is incorporated into the instructor software component of a classroom polling system 225 running on the instructor device 110 and the Student Application 230 is incorporated into the student software component of a classroom polling system 226 running a student device 120.

In operation, the present system discourages the student from distracted behavior. Distracted behavior may include using a mobile device 120 for purposes other than classroom participation. It may also include talking or engaging in other unproductive behavior at times when this behavior could disrupt other students in the class. Distracted behavior may also refer to any student behavior not associated with pedagogically productive participation in classroom learning activities, for example, playing games, watching videos, surfing the internet, using a calculator program when calculators are not allowed, etc.

Students engaging in distracted behavior are not benefitting fully from the instructional activities of the classroom. Students engaging in distracted behavior may be preventing nearby students from benefitting fully from the instructional activities of the classroom.

In one embodiment, before or at the beginning of class, the instructor launches the instructor version of the classroom polling application 225 containing the Instructor Application 210 and configures it for the class that is about to be taught. For example, the instructor may provide configuration data providing information about the class, such as class duration, a list of students expected to participate, a set of rules governing distracted behavior, other information, or some combination thereof. The configuration data may be prepopulated by extracting desired data from a database, such as university records, may include default values preset by the manufacturers of the classroom polling application, may include values manually entered by the instructor, or some combination thereof. In some embodiments, the configuration may be nothing more that accepting preprogrammed defaults or a predefined set of configurations. Such acceptance could be done simultaneously with launching the polling application or as a separate step.

Before or at the beginning of class, the student in the class launches the classroom polling application 226 including the Student Application 230 on the student device 120. Once again, for ease of reference, the operations of the system are described herein with respect to one student, but it should be understood that such operations described with respect to one student could apply equally to multiple students including some or all of the students in the class.

Following the protocol defined by the classroom polling system 225, 226 and using the wireless network connection 200 available to the classroom 100, two-way communication is enabled between the Instructor Application 210 and the Student Application 230.

In one embodiment, the student is instructed to place the student's mobile device 120 face-down on the student's desks. In other embodiments, the student may be instructed to place the student's mobile device in an alternate orientation, such as face-up on the student's desk.

The instructor selects the Suppress Distraction (SD) mode in the Instructor Application 210 of classroom polling system software application. The Instructor Application 210 sends data to the Student Application 230 including a command to the Student Application 230 in the student device 120 to enter Distraction Monitoring mode. The Student Application 230 enters Distraction Monitoring mode. The data may also include information setting forth or regarding rules that the Student Application should utilize during Distraction Monitoring mode. Data including information setting forth or regarding the rules may also be sent to the Student Application at an alternate time. In another embodiment, the information setting forth or regarding the rules may not be transmitted to the Student Application and instead it is available through the Instructor Application, the cloud, may be preprogrammed into the Student Application, may remain stored on the student device after a previous connection between the Instructor Application and the Student Application, or some combination thereof. It should be understood that the Instructor Application could send different rules to different students. For example, students in the front may receive rules that do not include monitoring the student device's microphone because it could have difficulty discerning student talking from the instructor lecturing and the instructor is close enough to overhear student talking. However, students in the back may receive rules to monitor the microphone because they may be more prone to talking. Thus, the rules can be tailored to fit different scenarios. In some embodiments, the Student Application may inform the student of one or more of the rules, in other embodiments, the Student Application may not.

Upon entering Distraction Monitoring mode, the Student Application 230 in the student device 120 begins to monitor one or more of the student device's sensors for the purpose of detecting distracted behavior. In one embodiment the Student Application 230 monitors the student device's accelerometer. In one embodiment the Student Application 230 in each student device 120 monitors each device's microphone in addition to, or instead of, the accelerometer, for the purpose of detecting distracted behavior. Those skilled in the art will appreciate that other sensors may be monitored in addition to, or instead of, the accelerometer, for the purpose of detecting distracted behavior.

The Student Application 230 may use data from the accelerometer to monitor, for example, the orientation or motion of the student device 120. If the location or orientation of the student device 120 is changed while the Student Application 230 is in Distraction Monitoring mode, this is registered by the Student Application 230 and interpreted as distracted behavior. The sensitivity or nature of the change, and what type of change should be interpreted by the Student Application as distracted behavior may be the subject of one or more rules. The Student Application may also use a default value of the student device, such as the requisite default acceleration change that a student mobile phone may use to determine whether to stop and mute a ringtone when moved.

In one embodiment the Student Application 230 uses data from the microphone to monitor sounds in the vicinity of the student device 120. If students are talking or creating other sounds not associated with classroom activities while the Student Application 230 is in Distraction Monitoring mode, this is registered by the Student Application 230 and interpreted as distracted behavior. The sensitivity or nature of the change, and what type of change or sound should be interpreted by the Student Application as distracted behavior may be the subject of one or more rules.

In one embodiment the Student Application 230 uses data from the camera to monitor light. If the camera is facing up, and the student turns the phone over so that the camera is facing down, the amount of light sensed by the camera will decrease. This decrease may be used as an indication of distracted behavior.

Other embodiments may monitor other or additional sensors and other or additional rules for identifying distracted behavior. It should be understood that while the Student Application could make the determination of distracted behavior, the data from the sensors could be sent by the Student Application to the Instructor Application and the Instructor Application could make the determination of whether distracted behavior exists.

After distracted behavior is detected, one of several actions may be implemented. In one embodiment, the Student Application 230 transmits a message to the Instructor Application 210 to notify the instructor. In one embodiment the Student Application 230 implements a corrective action.

One possible corrective action that may be implemented by the Student Application 230 in response to distracted behavior is that the Student Application 230 may use one or more transducers 270 of the mobile device 120 to issue a warning to the student to stop the distracted behavior. An example of a warning issued by the Student Application 230 to a distracted student may be issuing a sound using an audio transducer 270 of the student's mobile device 120. An example of a warning issued by the Student Application 230 to a distracted student may be the illumination or flashing of a light, display, or LED of the student's mobile device 120, or displaying a message on the screen of the student's mobile device 120. An example of a warning issued by the Student Application 230 to a distracted student could be energizing a vibrating transducer 270 of the student's mobile device 120.

Those skilled in the art will appreciate that any audio, visual, physical or haptic, or combination thereof, of signals may be created by a transducer 270 in the student's mobile device 120 and may be used to issue a warning to the student to stop the distracted behavior. The corrective actions implemented by the Student Application 230 in response to distracted behavior share the goal of discouraging the student from engaging in distracted behavior.

The warning may be issued once, repeatedly, or continuously. In one embodiment, the warring is issued until the change that resulted in the issuance of the warning stops. In another embodiment, the Student Application (or Instructor Application) analyses the change data and determines whether the student device has returned to the orientation it exhibited prior to the issuance of the warning. For example, when the Student Application receives data indicating that the student device has been moved from face-down to face-up, the Student Application may issue a warning until the sensors provide data indicating that the student device has moved from face-up to face-down (i.e. the original orientation of the student deice prior to the sensed change). The Student Application may continue to issue a warning until the student device is returned to the orientation it exhibited prior to the initial issuance of the warning or may issue a warning for some predetermined length of time.

When the instructor requires students to participate in class using their mobile devices the instructor may use the Instructor Application to disable, stop, or temporarily suspend, Suppress Distraction mode and Distraction Monitoring mode. In one embodiment, the instructor may send question data, which may include, for example, a question or a set of possible answers, using the instructor software of the classroom polling system 225. Sending the question data signals the Instructor Application 210 to, for example, suspend Distraction Monitoring mode and transmit, either separately or together with the question data, instructions to suspend Distraction Monitoring mode. It may also suspend Suppress Distraction mode on the instructor device. In one embodiment, the question data contains only the instruction to suspend, disable, or stop Distraction Monitoring mode, which indicates that the instructor may be asking a question aloud and allowing the student to use the student device to answer the question if desired.

When Suppress Distraction mode is disabled on the instructor device 110 the Instructor Application 210 transmits data to the Student Application 230 in the student device 120 including an instruction to disable Distraction Monitoring mode in the student device 120. It should be appreciated that the Launching the Instructor Application 210 could also serve to enter Suppress Distraction mode and that closing the Instructor Application could also be used to send an instruction to the Student Application to end Distraction Monitoring mode. The student could also close down the Student Application to end Distraction Monitoring mode. In one embodiment, the Instructor Application receives data indicating that a student device is running the Student Application and displays on the instructor device an indication of each student running the Student Application. In that embodiment, the instructor can see any students that turn off the Student Application, and the Instructor Application can generate an alert to the instructor indicating that a student either has not launched the Student Application or has shut down the Student Application.

Disabling Distraction Monitoring mode on a student's mobile device 120 allows students to talk, pick up, and use their mobile devices 120, and otherwise participate in class as instructed without corrective actions being implemented by the Student Application 230.

When the instructor determines that students no longer need to, for example, talk or use their mobile devices 120 for classroom participation, the Suppress Distraction mode is enabled and the class continues as previously described with respect to enabling Suppress Distraction (which may include enabling Distraction Monitoring mode). In one embodiment, to reenter Suppress Distraction mode and Distraction Monitoring mode, the instructor selects enable Suppress Distraction mode in a similar way to the first time the instructor enabled Suppress Distraction mode at the beginning of class. In one embodiment, sending question data to disable Distraction Monitoring mode, may include an additional instruction to reenter Distraction Monitoring mode after a trigger event.

Examples of a trigger event may include, but are not limited to, the expiration of a time period (such as 1 minute from the time Distraction Monitoring mode is suspended) and the transmission of an answer from the Student Application 230. In another embodiment, the instructor may store instructions for the Instructor Application 210 relating to when to instruct the Student Application to reenter Distraction Monitoring mode. For example, the instructions may instruct the Instructor Application to send signals to the student devices to reenter Distraction Monitoring mode upon expiration of a timer, or after the Instructor Application determines that all participating students have answered the question, or whichever trigger event occurs first. One of ordinary skill in the art will appreciate that alternative trigger events could be used and tailored to the specific desires of the instructor or based on the needs of a particular classroom, or both. This example illustrated the use of this invention to detect and correct distracted behavior by students in a classroom. Specifically, students are discouraged from using their mobile devices for purposes other than classroom participation, and students are discouraged from talking or engaging in other unproductive behavior at times when this behavior could disrupt other students in the class.

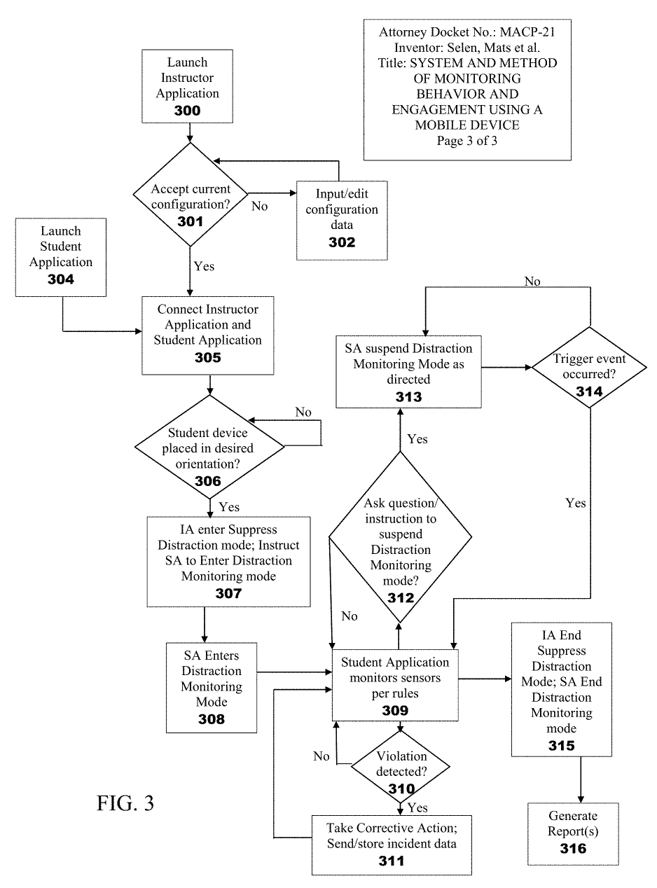

One embodiment of the present system may be understood with reference to the flowchart of FIG. 3. In it, the instructor launches the Instructor Application at 300. The Instructor may then accept the current configuration (for example, by doing nothing or by actively selecting an acceptance button in the Instructor Application), or the instructor may want to change the configuration at 301. If a change is desired, the instructor inputs or edits the configuration of the system, for example, by editing the rules for Suppress Distraction and Distraction Monitoring modes at 302. In the present embodiment, once the configuration is acceptable, the Instructor Application connects to the Student Application at 305. The student also launches the Student Application at 304. Once both the Instructor Application and Student Application are launched, each connects to the other at 305 so that the instructor device and Instructor Application may send and receive data from the student device and Student Application and vice versa.

The student places the student device in a desired orientation, such as face-down on the student's desk, at 306. The Instructor Application enters Suppress Distraction mode and instructs the student devices to enter Distraction Monitoring mode at 307. The Student Application then enters Distraction Monitoring mode at 308. Once in Distraction Monitoring mode, at 309 the Student Application checks the data of the sensor(s) of the student device against the rules configured by the Instructor to determine if a violation has occurred. If a violation occurs, such as a change detected by a sensor, see 310, the Student Application takes corrective action at 311, such as making a noise, and may send or store data relating to the incident as well. The Student Application then returns to monitoring the sensors.

The instructor may, through asking a question or by simply instruction, suspend Distraction Monitoring mode at 312. Where this occurs, the Student Application suspends Distraction Monitoring mode at 313. The Student Application then waits for a trigger event to occur at 314. Trigger events could be an instruction from the Instructor Application, an expiration of a timer, transmission of an answer, or some other event. Once the trigger event occurs, the Student Application returns to monitoring the sensors for changes at 309.

The Instructor Application may end Suppress Distraction mode and thereby send data to the Student Application to end Distraction Monitoring mode and the Student Application ends Distraction Monitoring mode at 315. In the embodiment described with reference to FIG. 3, the system may then generate one or more reports such as a spreadsheet or graph of data relating to students that experienced an incident where a change was detected.

Although various embodiments of the present system have been described herein, it is to be understood that such disclosure is not intended to be limiting. Various alterations and modifications will be readily apparent to those of skill in the art. Accordingly, it is intended that the appended claims be interpreted as covering all alterations and modifications as fall within the spirit and scope of the invention.

What is claimed is:

1. A behavior monitoring system comprising:
a student device including one or more sensors;
an instructor device, wherein the instructor device and the student device are each configured to transmit wireless data, receive wireless data, and process wireless data received;
an instructor software application including a Suppress Distraction mode, the instructor software application being executable by the instructor device;
a student software application including a Distraction Monitoring mode, the student software application being executable by the student device;
wherein the instructor software application enters Suppress Distraction mode and causes the instructor device to wirelessly transmit instruction data to the student device, the instruction data including instructions directing the student software application to enter Distraction Monitoring mode;
wherein the student software application is configured to
a. process wireless data and, upon receipt of the instruction data, process the instruction data and enter Distraction Monitoring mode;
b. at least after entering Distraction Monitoring mode, monitor one or more sensors of the student device; and
c. gather Engagement Telemetry relating to at least one or more sensors.

2. The system of claim 1, wherein the instructor software application causes the instructor device to transmit question data to the student device, the question data including and instruction directing the student software application to suspend or disable Distraction Monitoring mode.

3. The system of claim 2, wherein the instruction directs the student software application to suspend or disable Distraction Monitoring mode for a preset time such that, upon expiration of the pre-set time, the student software application reenters Distraction Monitoring mode automatically.

4. The system of claim 1 wherein the student software application is further configured to, at least after gathering Engagement Telemetry, transmit the Engagement Telemetry to the instructor device.

5. The system of claim 4 wherein the Engagement Telemetry includes information identifying the student device that gathered the Engagement Telemetry.

6. The system of claim 4 wherein the instructor device generates a report based on the information identifying the student device that gathered the Engagement Telemetry.

7. The system of claim 6 wherein the gathered Engagement Telemetry includes data relating to a change sensed by at least one sensor and the report includes information identifying at least one of the identity of the student device that included the sensor that detected the change, the type of change detected, the time the change was detected, and the duration of the change detected.

8. The system of claim 1 wherein the student software application is further configured to, at least after gathering the Engagement Telemetry, issue a warning to the student.

9. The system of claim 1 wherein the student software application is further configured to, at least after gathering the Engagement Telemetry, issue a warning to the student in the form of at least one of haptic feedback provided through the student device, auditory feedback provided through the student device, and visual feedback provided through the student device.

10. The system of claim 9 wherein the gathered Engagement Telemetry includes data relating to a change sensed by at least one sensor and the student software application is further configured to continue to issue the warning to the student until the change detected stops.

11. The system of claim 9 wherein the gathered Engagement Telemetry includes data relating to a change sensed by at least one sensor and the student software application is further configured to continue to issue the warning to the student until the student device is returned to the orientation it had just prior to the change resulting in the warning occurred.

12. The system of claim 1 wherein the student software application is further configured to, at least after gathering the Engagement Telemetry, wirelessly transmit the Engagement Telemetry to the instructor device;
wherein the Engagement Telemetry includes information identifying at least one of the identity of the student device and a type of change detected; and
wherein the instructor application is configured to cause the instructor device issue a warning to the instructor in the form of at least one of haptic feedback provided through the instructor device, auditory feedback provided through the instructor device, and visual feedback provided through the instructor device.

13. The behavior monitoring system of claim 12 wherein the student software application is further configured to repeatedly wirelessly transmit Engagement Telemetry to the instructor device until the change stops.

14. The behavior monitoring system of claim 12 wherein the student software application is further configured to repeatedly wirelessly transmit Engagement Telemetry to the instructor device until the student device returns to the orientation it had just prior to the change resulting in the initial transmission of Engagement Telemetry.

15. The behavior monitoring system of claim 12 wherein the student software application is further configured to transmit follow-up Engagement Telemetry to the instructor device;
wherein the follow-up Engagement Telemetry includes an indication that the change has stopped.

16. The behavior monitoring system of claim 12 wherein the instructor software application is configured to end Suppress Distraction mode and wirelessly transmit instruction data including at least an instruction directing the student software application to end Distraction Monitoring mode; and
wherein the instructor software application is configured to track the number of times a student device transmits Engagement Telemetry over a period of time within and including at least the time when the instructor application transmits the instruction data including instructions directing the student software application to enter Distraction Monitoring mode and the time when the instructor application transmits instruction data including at least an instruction directing the student software application to end Distraction Monitoring mode.

17. The behavior monitoring system of claim 1, wherein the student software application is configured to process wireless data and, upon receipt of the instruction data, process the instruction data and enter Distraction Monitoring mode without receiving external authorization.

18. A behavior monitoring system comprising:
a student device including one or more sensors and an instructor device, wherein the instructor device and the student device are each configured to transmit wireless data, receive wireless data, and process wireless data received;
an instructor software application including a Suppress Distraction mode, the instructor software application being executable by the instructor device;
a student software application including a Distraction Monitoring mode, the student software application being executable by the student device;
wherein the instructor software application includes one or more preset rules used to govern a determination of when a student will be considered distracted by the system;
wherein the instructor software application executes Suppress Distraction mode and causes the instructor device to wirelessly transmit instruction data to the student device, the instruction data including:
a. instructions directing the student software application to enter Distraction Monitoring mode; and
b. one or more of the preset rules;
wherein the student software application is configured to
a. process wireless data and, upon receipt of the instruction data, process the instruction data and enter Distraction Monitoring mode;
b. at least after entering Distraction Monitoring mode, monitor one or more sensors of the student device;
c. gather data generated by at least one or more sensors;
d. make a comparison between at least the data generated by at least one of the sensors and the preset rules; and
e. determine, based on the comparison, that the student should be considered distracted.

19. The behavior monitoring system of claim 18 wherein the preset rules comprise at least one of
a. a list of one or more approved URLs;
b. a list of one or more approved apps;
c. a list of one or more disapproved URLs;
d. a list of one or more disapproved apps;
e. a list of one or more threshold values relating to changes the student device may experience while in Distraction Monitoring mode;
f. a list of one or more acceptable absolute values relating to at least one sensor; or
g. a list of one or more unacceptable absolute values relating to at least one sensor.

20. The system of claim 18 wherein the student software application is further configured to, at least after determining that the student should be considered distracted, wirelessly transmit Engagement Telemetry to the instructor device;
wherein the Engagement Telemetry includes information identifying at least one of the identity of the student device and an indication of a result of the comparison; and
wherein the instructor application is configured to cause the instructor device to issue a warning to the instructor in the form of at least one of haptic feedback provided through the instructor device, auditory feedback provided through the instructor device, and visual feedback provided through the instructor device.

21. The behavior monitoring system of claim 18 wherein the student software application is further configured to compare multiple changes sensed by at least one sensor, compare the multiple changes sensed, and, based at least on the multiple changes sensed, determine that the student should not be considered distracted.

22. The behavior monitoring system of claim 18 wherein the student software application is further configured to repeatedly wirelessly transmit Engagement Telemetry to the instructor device until the student software application determined that the student should not be considered distracted.

23. The behavior monitoring system of claim 18 wherein the student software application is further configured to transmit follow-up Engagement Telemetry to the instructor device after the student software application determines that the student should not be considered distracted;
wherein the follow-up Engagement Telemetry includes an indication that the student should not be considered distracted.

24. The behavior monitoring system of claim 18 wherein the instructor software application is configured to end Suppress Distraction mode and wirelessly transmit instruction data including at least an instruction directing the student software application to end Distraction Monitoring mode; and
wherein the instructor software application is configured to track the number of times a student device transmits Engagement Telemetry over a period of time within and including at least the time when the instructor application transmits the instruction data including instructions directing the student software application to enter Distraction Monitoring mode and the time when the instructor application transmits instruction data including at least an instruction directing the student software application to end Distraction Monitoring mode.

25. The behavior monitoring system of claim 18, wherein the student software application is configured to process wireless data and, upon receipt of the instruction data, process the instruction data and enter Distraction Monitoring mode without receiving external authorization after the time when the student device enters Distraction Monitoring mode for the first time in a class.
